(19) United States
(12) Patent Application Publication
(10) Pub. No.: US 2003/0208481 A1
(43) Pub. Date: Nov. 6, 2003

(54) Comparison of application protocols

(76) Inventor: Ralf Neumann, Dinslaken (DE)

Correspondence Address: BAZERMAN & DRANGEL, P.C., 60 EAST 42ND STREET, SUITE 820, NEW YORK, NY, 10165, US

(21) Appl. No.: 10/430,070

(22) Filed: May 6, 2003

(30) Foreign Application Priority Data
May 6, 2002 (DE) 102 20 204.4
Nov. 6, 2002 (EP) 02 024 711.0

(51) Int. Cl. G06F 7/00

(52) U.S. Cl. 707/3

(57) ABSTRACT

A method for the automatic comparison of at least two different application protocols is described in which actions triggered in a database are logged in a first application protocol of at least one first program, and in which actions triggered on a database are logged in a second application protocol of at least one second program group. A hardware independent analysis of the performance of programs groups is thus made possible, that during logging at least page requests from a data management layer to a memory management layer are logged, and that at least one part of the page requests logged in the first application protocol are compared to at least one part of the page requests logged in the second application protocol.

### PRIORITY

This application claims priority of German patent application number 102 20 204.4, filed on May 6, 2002, and of European patent application number 02 024 711.0, filed on Nov. 6, 2002, both pending.

### FIELD OF THE INVENTION

The invention relates to a method for the automatic comparison of at least two different application protocols in which actions triggered by a first program in a database are logged in a first application protocol, and in which actions triggered by a second program in the database are logged in a second application protocol.

The invention further relates to a computer program product for the execution of a comparison of two different application protocols through which a first application protocol is created by actions triggered by a first program in a database and through which a second application protocol is created by actions triggered by a second program in a database.

The invention also relates to a device for the automatic comparison of at least two different application protocols with a logging device for recording a first and a second application protocol, with at least one access device accessing data in a database, and with a recording device for recording activities triggered in the database by the first or second programs executed on the access device, wherein the recorded activities are transmittable to the logging device and are assigned to the respective application protocols in the logging device.

Finally, the invention is also related to a use of this type of a process, this type of a computer program product, or this type of a device.

### BACKGROUND OF THE INVENTION

Access to databases, in particular relational databases such as DB2 from IBM, is triggered by external programs or program groups. According to the invention, the term “programs” is understood to refer both to program groups as well as to individual programs. A program group comprises elements (packages). Each element can trigger database activities. Said activities can be inquiries, substitutions, deletions, or other activities. For example, data stored in the database are retrieved on the basis of determinable parameters in the course of an inquiry. Standardized interfaces are utilized to trigger database activities. An interface of this kind is the structured query language (SQL) interface. Database activities or inquiries of this kind are called SQL queries.

Actions are triggered in the database when activity is performed with the help of an SQL query. Stored data is processed by these actions whereby a response to database queries is made possible. Depending on the respective database query, as well as on a sequence of several database queries, the response time to one and the same query or sequence of queries may vary from one another. This is of interest if programs or program versions are to be compared to each other.

Programs are substituted over the course of time. Substituted program versions may result in different database performance. On the one hand, this may be attributable to the fact that the queries of the programs, when compared with each other, have changed. Query response times possibly change due to substituted data structures within the database. In this case, substituted access paths are eventually needed to improve database performance. Also, tables in which the entries are stored possibly change in size due to a change in the number or type of entries. Among other things, these three factors can determine the internal performance of a database, in particular the database's response times to inquiries.

The hardware configuration on which a database works can also change in the course of time. An improved hardware configuration leads to faster processing of database queries under certain circumstances. However, this is not a result of an optimized database query or an improved program version, but is rather attributable to improved hardware.

Currently, it is not possible to make a definitive ascertainment as to how substitutions within program versions affect the performance of a database query or a multitude of database queries. Better response time is possibly achieved due to an improved hardware configuration in comparison to a database query issued by a less powerful previous version. In this way, however, programs can no longer be compared in such a manner that the database queries are found, which from an objective standpoint, that return the poorer results.

Therefore, it is an object of the present invention to facilitate a comparison of programs, program groups, or database queries that operate on a database regardless of the hardware configuration.

The aforesaid object is already inventive in its own right. The comparison of database queries in different program versions independent of the underlying hardware configuration was not known until now.

### SUMMARY OF THE INVENTION

In accordance with the present invention, a method is proposed to automatically compare at least two different application protocols. Said method is characterized in that during logging page requests from at least one data management layer is logged in a memory management layer, and that at least one part of the page requests logged in the first application protocol is compared to at least one part of the logged page requests in the second application protocol.

When application protocols (performance traces) are written, the access operations and actions within a database are logged. In accordance with the invention, specifically the page requests of a data management layer to a memory management layer constitute an opportunity for a comparison that is independent of the underlying hardware. The page requests are transferred from the data management layer to the memory management layer.

For example, a data management layer transfers a number of getpage orders that were triggered by a single database query to a buffer pool manager layer (memory management layer). In a new program version, the data manager layer transfers a different number of getpages for the corresponding database queries to the buffer pool manager layer. This means that the access time changes in order to reply to database queries. Processing a majority of page accesses is possible within a shorter period of time with a better hardware configuration. This does not mean, however, that a program makes greater performance available. An increase in performance, regardless of hardware configuration, can be determined when fewer page requests are needed for the same tasks in the database.

Thus, in accordance with a preferred embodiment of the invention, the page requests that are logged with the help of the application protocols are compared with each other. A first application protocol logs the page requests of a first program version, for example. Said application protocol can be saved. For example, information about the SQL texts, their source (plan, collection, package, version) CPU time, elapsed time, and getpages can be stored within a table, for example, a DB2 table, in the application protocol. The same information is also stored in a second application protocol when a newer program version has been installed, for example. Comparison of the application protocols reveals the differences in the number of page requests. Said comparison determines whether the page requests between two application protocols have changed. If substitutions exist within the page requests, the performance of a program version could have changed. This may also depend on the access strategy of the database on the tables, the table sizes, or also the object sizes.

In accordance with the invention, it is proposed to present results that are independent of external factors, for example, an output listing of the page requests, as well as the SQL texts, the access paths, the table sizes, etc.

In accordance with the invention, it is preferred to assign page requests and programs of the program groups to each other. Said assignment determines in which programs there have been substitutions. This simplifies a subsequent analysis of programs because the programmer immediately knows which program has caused a substitution of the page requests. An improvement in performance can then be achieved by analyzing and substituting the respective program.

In accordance with another preferred embodiment of the invention, it is proposed to simplify the analysis of program versions by assigning the page requests to the database queries of the programs that are assigned to the program groups. A variety of database queries are triggered within programs. Each database query causes page requests. By assigning the page requests to the respective database query, the programmer can be given even more detailed information as to why and where the substitutions of the page requests have taken place.

The assignment of a page request to a program group, a program or a database query is inventive in and of itself independent of the comparison in accordance with the invention. By assigning logged page requests to the programs, they can be analyzed very specifically.

In this context, it is in any case preferred if page requests to program groups, programs, or database queries assignable to each other can be compared with each other. With at least two program groups which are logged with application protocols, for example, two different program versions, at least several of the programs or database queries therein correspond to each other. Substitutions in the program groups generally relate to only a small part of the programs or database queries therein. The database queries or programs can be assigned to each other in accordance with the preferred organization between the two logged program groups and compared to the page requests caused by them. Comparing the application protocols establishes which of the programs or database queries are assignable to each other and the page requests they generate are then compared.

In particular, the number of page requests is a measure for the performance of a program. Therefore, in accordance with a preferred embodiment of the invention, it is proposed to compare the number of page requests with each other. If the number of page requests has increased from one program to the next or from one version to a newer version, the corresponding program or the corresponding database query is eventually less able to perform than its previous version. In addition to the number of page requests, the table size as well as the access path selected by the database is also decisive for program performance.

In accordance with another preferred embodiment of the invention, it is proposed to minimize the number of page requests and programs or databases to be compared by determining a threshold number of page requests. Said minimum number is freely determinable. A comparison is not conducted until a certain number of page requests produced by a program has been reached. This means, for example, that only programs that create more than one page request within the database are compared to its counterpart of the other program, for example, the newer version, in regard to page requests.

Also in accordance with another preferred embodiment of the invention, it is proposed to average the page requests triggered by a program, a program group and/or a database query. Averaging permits an evaluation independent of statistical outliers. A comparison is possibly not conducted until the average lies above a determinable minimum number.

In the comparison in accordance with a preferred embodiment, the absolute deviation and/or percent deviation of the page requests between programs and/or database queries assignable to each other is determined. With this information, the performance of a program or a database query can more likely be ascertained.

The assignment of programs and/or database queries along with their number of deviations in the page requests makes it possible to accurately determine, for a later analysis, the degree of substitution as well as the source of the substitution between two program versions.

In accordance with yet another preferred embodiment of the invention, it is proposed to eliminate minor changes in the page requests from analysis by determining an absolute or percent minimum value for the number of deviations or their average. If the absolute or percent deviation of page requests exceeds the determinable minimum value, the corresponding programs or database queries are presented. This can take place together with the number of the deviations in the page requests. The percent deviation can also be presented.

In accordance to another preferred embodiment of the invention, it is proposed to improve the analysis of the respective database queries or programs by comparing the syntax of the programs and/or database queries with each other and to present the differences in the syntax. In the process, syntactical elements are extracted and compared with each other. Substitutions in the query text of the database queries or programs need not be considered in the process; only the syntactical elements need be compared to each other.

Also in accordance with the invention, it is preferred to determine the application protocol by querying a standard interface. For example, in a DB2 database from IBM, logging is possible with the help of the Instrumentation Facility Interface (IFI). A multitude of database activities can be logged (traced) by means of different Instrumentation Facility IDs (IFC IDs) on the Instrumentation Facility Interface (IFI). The desired information can be obtained by placing the right queries of certain Instrumentation Facility IDs. For example, via the Instrumentation Facility ID 198, every getpage query from a data management layer to a memory management layer can be inquired.

The assignment of page requests to the respective programs and/or database queries can be achieved in that the queries of the standard interface are combined with each other. For example, every page request can be assigned to a corresponding database query, program (package) and program group via a correct combination of Instrumentation Facility IDs to retrieve information about Getpages, Fetches, Selects, Updates, Inserts, Deletes, SQL texts, Prepares, Opens, Closes, Ends.

Another object of the invention with whose help the technical problem of the invention is also solved is a computer program, in particular according to a previously described method in which page requests from a data management layer of the database to a memory management layer in the database are recorded and logged and, in which a comparison is conducted between at least one part of the page requests logged in the first application protocols and at least one part of the page requests logged in the second applications protocols.

Another object of the invention is a device, in particular with a method or a computer product previously described in which the recording device is provided for the recording of page requests of a data processing device to a memory management device within the database, and in which a comparison device is provided for comparing at least one part of the logged page requests of the application protocols. The page requests are logged with the help of the recording device. In the process, for example, a standardized interface of the database is queried by the recording device. The recorded page requests are logged and compared in the comparison device with a previous application protocol. For example, determination of application protocols of different program versions is possible through the device. These application protocols can then be compared with each other.

Another object of the invention proposes to use a previously described method, a previously described computer program product, or a previously described device in a relational database. A relational database of this kind is, for example, a DB2 database from IBM. Said database can be used to supply management programs with data, for example, SAP R/3 or insurance or financial programs. Said programs cause the database queries and page requests.

### BRIEF DESCRIPTION OF THE DRAWINGS

The invention is explained in detail in the following on the basis of drawings illustrating an embodiment of the invention. In the drawings:

FIG. 1 shows a schematic layer structure of a database,

FIG. 2 shows the sequence of a method in accordance with the invention, and

FIG. 3 shows the structure of a device in accordance with the invention.

### DETAILED DESCRIPTION OF THE INVENTION

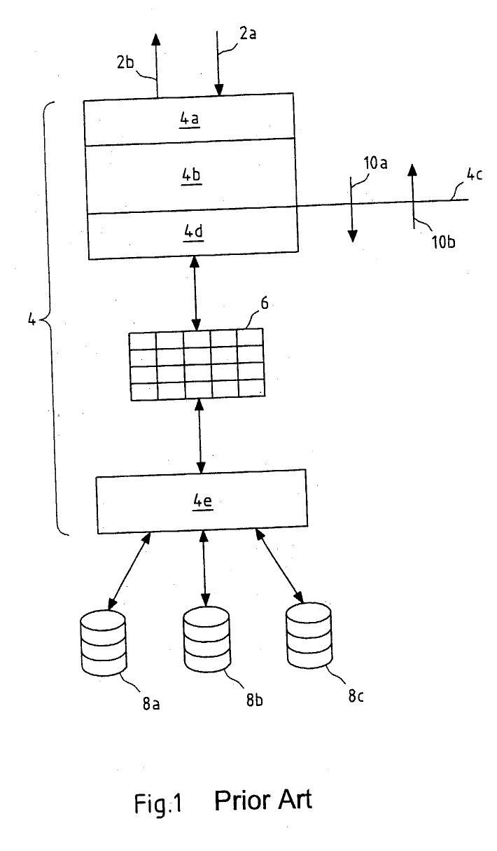

FIG. 1 shows the layer structure 4 of a conventional database, for example, the DB2 database from IBM. Schematically and functionally, a database comprises of a relational data system (RDS) layer 4a, a data manager layer 4b, a buffer pool manager layer 4d, and a media manager layer 4e, among other things. This layer structure 4 is a possible layer structure that makes it possible for the database to answer SQL queries 2.

The buffer pool manager layer 4d accesses a virtual buffer pool 6. The virtual buffer pool 6 is formed in the form of a table with 4K blocks. Each of the 4K blocks can comprise a page of the database. Blocks of the virtual buffer pool 6 are filled from the table 8 via the media manager layer. A page request from the buffer pool manager layer 4d to the virtual buffer pool 6 is answered directly, if the page is present in a 4K block within the virtual buffer pool 6. If this page is not present within the virtual buffer pool 6, a query is placed to the media manager layer 4e which has access to the tables 8a, b, and c. The requested page is loaded from one of the tables 8a, b, or c and made available in one 4K block of the virtual buffer pool 6.

Via the data manager layer 4b, page requests 10a are made to the buffer pool manager layer 4d via the interface 4c. The page requests 10a are simply dependent on the type and sequence of the SQL queries 2a. The number of page requests 10a depends on the number and size of the virtual buffer pool 6 as well as its 4K blocks. A page request 10a is answered 10b by the buffer pool manager layer 4d by way of the interface 4c.

Regardless of whether a page must be requested in the virtual buffer pool 6 or by way of the media manager layer 4e, a page request 10a is answered. This means that the page requests 10a to the interface 4c are independent of the hardware configuration of the database.

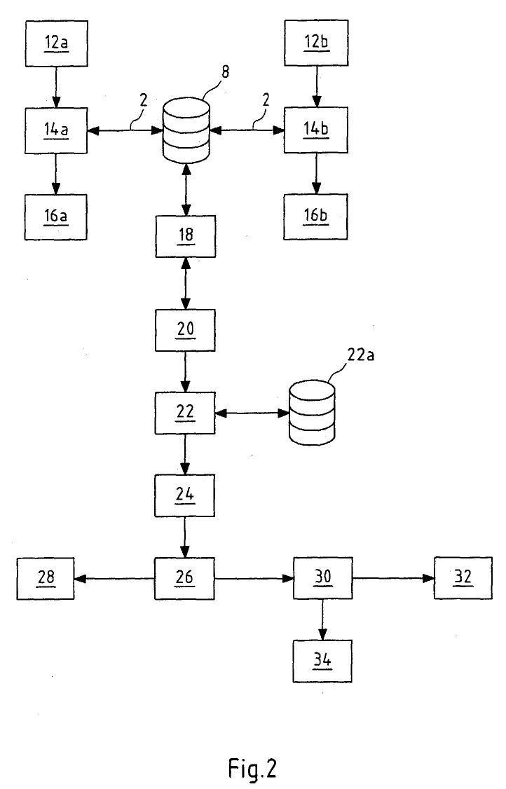

To ascertain the performance of individual database queries, programs or program groups, it is proposed to create performance traces of DB2 and that said traces be compared with each other. To this end, a method as illustrated in FIG. 2 is proposed.

Programs 12 access a database 8. Said programs 12 can be made available sequentially in terms of time. For example, program 12a is a previous version of a program 12b. In order now to be able to determine how the performance of program 12b has changed vis-a-vis the previous program 12a, a comparison of performance traces is preferred.

The programs 12 access the database 8 by way of SQL queries 2 in step 14 during its runtime. Once all program steps have been processed, the programs 12 are terminated in step 16. While the access operations in step 14 of the programs 12 affect the database 8, the SQL queries cause actions within the database 8. These actions can be logged by means of an interface 18.

Said interface 18 is, for example, an Instrumentation Facility Interface (IFI). Different activities can be queried via Instrumentation Facility IDs (IFC IDs). The following activities can be queried, for example: Getpages, Fetches, Selects, Updates, Inserts, Deletes, SQL Texts, Prepares, Opens, Closes, Ends. All of these actions can be triggered when an SQL query 2 is made to the database 8. The interface 18 is accessed to create a performance trace. In the process, suitable Instrumentation Facility IDs are selected that are to be logged. These are, for example, the aforementioned Instrumentation Facility IDs. The running of the programs 12 is logged 20, and the performance trace is written 22 in a table 22a. In the process, information can be stored about, for example, SQL texts, sources (plan, collection, package, version) CPU times, elapsed times, and getpages. Moreover, the access paths of all SQL queries can be determined via the interfaces 18 and stored 22 in the table 22a.

The stored performance traces are then compared 24 with each other. In the process, the page requests are assigned to the respective program groups of the programs 12a and 12b. Page requests are possibly assigned to parts of programs (packages) of programs 12a or 12b. Page requests are possibly assigned to individual database queries 2 of the programs 12a or 12b.

During the comparison 24 of the performance traces, the program groups, programs, parts of programs or database queries assigned to each other are compared with reference to the number of page requests. This means that the respective substitutions in the programs are determined with regard to their produced page requests.

For the programs assigned to each other in each case, the absolute number of page requests is determined 26. If the absolute number of page requests is less than a determinable minimum number, the programs are flagged and must no longer be considered 28 in the analysis.

If the absolute number of page requests is greater than the determinable minimum number, an absolute or percent different in page requests between the programs assigned to each other is determined 30. If the absolute or percent difference is less than a determinable minimum size, these programs are also flagged 32.

If the absolute or percent difference in page requests between two assigned programs is greater than the determinable minimum value, such programs are presented 34 together with the number, the difference, and the percent deviation of page requests. Access paths and table sizes can also be presented in order to be able to evaluate performance and the substitutions also under consideration of changing outline conditions for the database.

Following this, analysis of programs in regard to their syntax is performed. Said syntax analysis makes it possible to exactly determine the substitutions and thereby simplifies an optimization of programs.

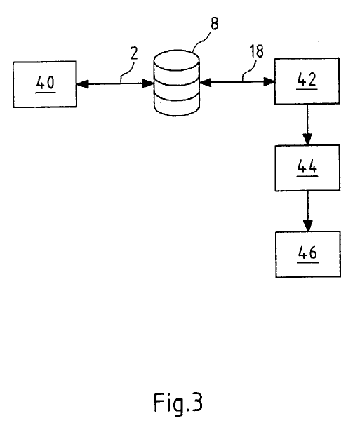

FIG. 3 illustrates a device according to the invention. An access device 40 permits programs to access a database 8 using SQL queries 2. Program versions that change over time run on the access device 40. In order to be able to compare these program versions, a number of actions from a first program version and a second program version are logged via the interface 18 with the help of a recording device 42. Using a logging device 44, a performance trace is determined for the first program version and the second program version that runs on the access device 40 in which case the recorded actions are logged.

Both of these performance traces are passed on to the comparison device 46 and compared there in regard to page requests.

Although the description above contains many specificities, these should not be construed as limiting the scope of the invention but as merely providing illustrations of some of the presently preferred embodiments of this invention. Thus, the scope of the invention should be determined by the appended claims and their legal equivalents rather than by the examples given.

I claim:

1. A method for the automatic comparison of at least two different application protocols, wherein
actions triggered in a database are logged in a first application protocol of at least one first program;
actions triggered in the database are logged in a second application protocol of at least one second program;
the logging comprises the logging of page requests directed by at least one data management layer to a memory management layer; and
at least one part of the page requests logged in the first application protocol are compared with at least one part of the page requests logged in the second application protocol.

2. The method of claim 1, wherein page requests and programs of program groups are assigned to each other.

3. The method of claim 1, wherein the page requests are assigned to database queries of the programs assigned to program groups.

4. The method of claim 1, wherein the page requests of program groups, programs or database queries assignable to each other are compared.

5. The method of claim 1, wherein the number of page requests are compared with each other.

6. The method of claim 1, wherein a minimum number of page requests is determined from which a comparison is conducted.

7. The method of claim 1, wherein an average value of page requests triggered by a program, a program group and/or a database query is formed.

8. The method of claim 1, wherein the absolute and/or percent deviation of the page requests between programs and/or database queries assignable to each other is determined.

9. The method of claim 1, wherein programs and/or database queries assignable to each other are presented together with the number of deviations in the page requests.

10. The method of claim 1, wherein an absolute or percent minimum value for the number of deviations is determined from which programs and/or database queries assignable to each other are presented together with the number of deviations in the page requests.

11. The method of claim 1, wherein the syntax of the assigned programs and/or database queries is compared to each other and differences in the syntax are presented.

12. The method of claim 1, wherein the application protocol is determined by querying a standard interface.

13. The method of claim 1, wherein the page requests from a combination of queries of at least two activities callable via the standard interface can be allocated to the programs and/or database queries.

14. The method of claim 1, wherein the database used is a relational database, such as an IBM DB2 database.

15. A computer program product for performing a method of comparing two different application protocols, in which method
a first application protocol of actions triggered in a database by at least a first program is created;
a second application protocol of actions triggered in a database by at least one second program is created;
page requests from a data management layer of the database to the memory management layer of the database are recorded and logged, and
a comparison between at least one part of the page requests logged in the first application protocols and at least one part of the page requests logged in the second application protocols is conducted.

16. A device for an automatic comparison of at least two different application protocols comprising (a) a logging device for recording of a first and a second application protocol; (b) at least one access device for accessing data within a database; and (c) a recording device for recording activities in the database triggered by the access device of executed first or second programs, wherein
the recorded activities are transmittable to the logging device and can be assigned to the respective application protocols in the logging device;
the recording device is capable of recording page requests made by a data processing device to a memory management device within the database, and wherein
a comparison device for comparing at least one part of the logged page requests of the application protocols is provided.

17. Use of a method for the automatic comparison of at least two different application protocols, wherein
actions triggered in a database are logged in a first application protocol of at least one first program;
actions triggered in the database are logged in a second application protocol of at least one second program;
the logging comprises the logging of page requests directed by at least one data management layer to a memory management layer; and
at least one part of the page requests logged in the first application protocol are compared with at least one part of the page requests logged in the second application protocol;
in a relational database.

18. Use of a computer program product for performing a method of comparing two different application protocols, in which method
a first application protocol of actions triggered in a database by at least a first program is created;
a second application protocol of actions triggered in a database by at least one second program is created;
page requests from a data management layer of the database to the memory management layer of the database are recorded and logged; and
a comparison between at least one part of the page requests logged in the first application protocols and at least one part of the page requests logged in the second application protocols is conducted;
in a relational database.

19. Use of a device for an automatic comparison of at least two different application protocols, said device comprising (a) a logging device for recording of a first and a second application protocol; (b) at least one access device for accessing data within a database; and (c) a recording device for recording activities in the database triggered by the access device of executed first or second programs, wherein
the recorded activities are transmittable to the logging device and can be assigned to the respective application protocols in the logging device;
the recording device is capable of recording page requests made by a data processing device to a memory management device within the database, and
a comparison device for comparing at least one part of the logged page requests of the application protocols is provided;
in a relational database.
